(19) United States
(12) Patent Application Publication
(10) Pub. No.: US 2023/0359018 A1
(43) Pub. Date: Nov. 9, 2023

(54) OPTICAL DEVICE FOR DEFLECTING A LIGHT BEAM AND INELASTIC DIFFUSION SPECTROMETER COMPRISING SUCH A DEVICE

(71) Applicant: HORIBA FRANCE SAS, Palaiseau (FR)

(72) Inventor: Vasily GAVRILYUK, Lambersart (FR)

(21) Appl. No.: 18/028,582

(22) PCT Filed: Sep. 27, 2021
(86) PCT No.: PCT/EP2021/076528

§ 371 Date: Mar. 27, 2023

(30) Foreign Application Priority Data
Sep. 28, 2020 (FR) 2009829

(51) Int. Cl. G02B 26/08; G01J 3/44; G01J 3/02; G02B 26/10

(52) U.S. Cl. CPC G02B 26/0816; G01J 3/4412; G01J 3/021; G01J 3/0229; G02B 26/10

(57) ABSTRACT

Disclosed is an optical device for deflecting a light beam, including: —a first flat reflective element arranged so as to reflect an incoming light beam into a reflected light beam, extending in a first plane, the incoming light beam and the reflected light beam defining an incidence plane; and —a second flat reflective element, arranged to reflect the reflected light beam into an outgoing light beam, extending in a second plane that is transverse to the plane of incidence. The first plane and the second plane are secant along a line of intersection and form between them a dihedral angle. The first reflective element and the second reflective element can be rotated together about an axis of rotation substantially coincident with the line of intersection.

### CROSS-REFERENCE TO RELATED APPLICATIONS

This application is the U.S. national phase of International Application No. PCT/EP2021/076528 filed Sep. 27, 2021, which designated the U.S. and claims priority to FR Patent Application No. 2009829 filed Sep. 28, 2020, the entire contents of each of which are hereby incorporated by reference.

### TECHNICAL FIELD OF THE INVENTION

The present invention generally relates to an optomechanical system for adjusting the angle of incidence of a light beam on an optical element.

More particularly, it relates to an optomechanical light-beam deflection device.

Such a device finds in particular applications in the spectral filtering with variable angle of incidence, for example in Raman spectrometry instruments equipped with interference filters.

### TECHNOLOGICAL BACKGROUND

In complex optical measurement systems, such as spectrometers, it is often useful to adjust the angle of incidence of a light beam on an optical element (such as an interference filter) while preserving the direction and position of the reflected and/or transmitted beam.

Indeed, the performances of an interference filter depend on the angle of incidence of the beam. This means that their spectral response (for example, the bandwidth, the cut-off wavelengths or the transmission) varies in particular as a function of the angle of incidence of the light beam on the interference filter.

In particular, in a Raman spectrometer, it is known to use an injection-rejection filter (for example, of the interference type) that may be a band-stop filter with a very narrow spectral bandwidth and steep edges (also called “Notch filter”) or a high-pass or low-pass filter (also called “Edge filter”). For example, injection-rejection filters of the interference type are used in a Raman spectrometer or a Raman microspectrometer.

Edge interference filters are high-pass or low-pass filters having a wide rejection band and a steep edge. Their low price explains their wide use in optical measurement instruments.

Notch interference filters are band-stop filters appreciated for their steep edges and their narrow rejection band liable to reach a mid-height width of only a few nanometres.

The use of a notch or edge interference filter in a Raman spectrometer makes it possible, on the one hand, to illuminate the sample with a filtered laser beam (hence highly monochromatic) and, on the other hand, to reject from the backscattered beam the reflection and the Rayleigh scattering that have the same wavelength as the incident beam, while letting through the inelastic scattering characteristic of the sample (including the Raman scattering) at wavelengths different from the incident wavelength. A notch filter makes it possible to measure the strokes and anti-stokes lines.

In a notch interference filter (used in reflection and in transmission), a backscattered beam whose wavelength is included in the rejection band is reflected by the filter whereas the other wavelengths pass through it.

Therefore, in a Raman spectrometer, a notch interference filter is first used in reflection on the incident laser beam to reflect towards the sample a laser beam that is highly monochromatic around the reference wavelength of the laser.

Then, the same notch interference filter is used in reflection on the backscattered beam to reflect the reflection and the Rayleigh scattering at the same wavelength as the incident laser beam and in transmission to let through the Raman scattering, typically towards a spectrum analyser.

In spectrometry and in particular Raman spectrometry, it is often necessary to vary the laser wavelength as a function of the sample to be studied. Varying the laser wavelength may serve to vary the spectral band(s) detected and to obtain a spectrally extended Raman spectrum and/or a low-frequency Raman spectrum (i.e. in a spectral band very close to the incident beam wavelength). To filter the reflection and the Rayleigh scattering at the same wavelength as the laser, it is then possible to adapt the rejection band of the interference filter by changing the angle of incidence of the backscattered beam. For that purpose, an interference filter used in reflection and in transmission may be mounted on a support linked to a mechanical actuator (for example, a motor) allowing the support to perform a rotation (in the plane of incidence), whose angle is determined as a function of the laser wavelength.

However, changing the angle of incidence of a beam on a reflective element also changes the reflection angle. Changing the reflection angle requires adapting the optical path in such a way, for example, that the filtered laser beam is always oriented towards the sample and that the inelastic scattering beam, for example the Raman beam, is always oriented towards the spectrum analyser.

In Raman microscopy, it is desired to inject the incident laser beam along the axis of the microscope lens and to collect the backscattered beam along this same axis.

To adapt the optical path, a solution consists in mounting an auxiliary mirror on a kinematic mount to allow it to perform a translation movement (substantially along the filtered beam) and a rotation movement so as to keep the direction and position of the laser beam in the axis of the microscope and to also keep the direction and position of the backscattered Raman beam with respect to the spectrum analyser. For that purpose, the interference filter and mirror rotations and the mirror lateral movement must be performed in a combined manner, with a great accuracy, which requires complex and expensive mechanics.

Generally, it is desirable to reduce the bulk of the spectrometers, for example by limiting the number of movable parts and the number of motors or actuators, while improving the measurement performances thereof.

### SUMMARY OF THE INVENTION

In this context, the present invention proposes a optical light-beam deflection device comprising: a first flat reflective element extending in a first plane, the first reflective element being arranged in such a way as to reflect an incoming light beam into a reflected light beam, said incoming light beam and said reflected light beam defining a plane of incidence; and a second flat reflective element extending in a second plane transverse to the plane of incidence, the second reflective element being arranged in such a way as to reflect said reflected light beam into an outgoing light beam; said first plane and said second plane being secant along a line of intersection and forming between each other a predetermined dihedral angle as a function of a chosen angle of deflection, said first reflective element and said second reflective element being jointly rotatable about an axis of rotation coincident with said line of intersection, said axis of rotation being transverse to the plane of incidence.

Therefore, thanks to the rotational mobility of the reflective elements, it is possible to adapt the angle of incidence of a light beam on the first reflective element and the second reflective element while ensuring constant direction and position for the outgoing light beam. For that purpose, the first reflective element and the second reflective element arranged in a corner perform a joint rotation about an axis of rotation coincident with the line of intersection of their respective planes.

With the optical deflection device, keeping the direction and position of the outgoing light beam requires no particular adjustment such as moving or reorienting auxiliary mirrors. Indeed, the exit angle between the outgoing beam and the incoming light beam is independent of the angle of rotation of the first and second reflective elements about the axis of rotation. Moreover, the position of the outgoing beam is unchanged when the device performs a rotation about the axis of rotation.

According to a particular aspect of the invention, one at least among said first reflective element and said second reflective element is a spectral filter.

The optical deflection device thus makes it possible to simply change the angle of incidence of a light beam on the spectral filter without worrying about realigning the outgoing beam. However, the spectral filter advantageously has optical properties (in reflection and/or in transmission) that vary as a function of the angle of incidence.

Adjusting the angle of incidence of a light beam on a reflective optical element while preserving the direction and position of the reflected beam may also be useful in light-matter interaction measurement instruments. For example, in the case of plasmon resonance, the angle of incidence on the sample may be adjusted while guaranteeing that the reflected beam is always directed towards the detector, i.e. without changing the point of incidence of the reflected beam on the sensitive surface of the detector. This makes it possible, among other things, to increase the measurement accuracy.

It is therefore possible to adapt the spectral response of the spectral filter, for example to adapt to the wavelength of an incident laser beam, by performing a single adjustment: a joint rotation of the two reflective elements. After calibration, the angle of rotation makes it possible to adjust the spectral response of the interference filter to the laser wavelength.

Other non-limiting and advantageous features of the optical light-beam deflection device according to the invention, taken individually or according to all the technically possible combinations, are the following:
said first reflective element is a flat mirror;
said second reflective element is a flat reflection filter;
said filter is an interference filter of the stop-band, high-pass, low-pass or band-pass type;
said interference filter operates in transmission and in reflection;
said first reflective element and said second reflective element are fastened to a common platform that is rotatable about said axis of rotation;
said first reflective element and/or said second reflective element is adapted to move in translation in said first plane and/or, respectively, said second plane;
said first reflective element and said second reflective element are adapted to jointly move in translation in the plane of incidence, along a bisector between a direction of the incoming light beam and a direction of the outgoing light beam;
at least one of said first reflective element and second reflective element has reflection properties that vary over its surface;
the dihedral angle is between 20 degrees and 70 degrees.

The invention also proposes an optical inelastic scattering-based spectrometer comprising the optical light-beam deflection device. Such an optical inelastic scattering-based spectrometer finds in particular applications in Raman spectrometry.

Advantageously, the optical spectrometer may be combined with a confocal microscope. Such an instrument finds in particular applications in Raman microspectrometry.

### BRIEF DESCRIPTION OF THE DRAWINGS

The following description in relation with the appended drawings, given by way of non-limiting examples, will allow a good understanding of what the invention consists of and of how it can be implemented. The invention is not limited to the embodiments illustrated in the drawings. Therefore, it should be understood that, where the features mentioned in the claims are followed with reference signs, these signs are included solely for the purpose of improving intelligibility of the claims and do not limit the scope of the claims in any way.

In the appended drawings:

FIG. 1 is a schematic cross-sectional view of an optical light-beam deflection device according to the invention;

FIG. 2 is a schematic cross-sectional view of the optical light-beam deflection device of FIG. 1, representing an adjustment by rotation;

FIG. 3 is a schematic cross-sectional view of the optical light-beam deflection device of FIG. 1, representing an adjustment by translation;

FIG. 4 is a schematic representation of an inelastic scattering-based spectrometer, for example a Raman spectrometer, comprising the optical light-beam deflection device of FIG. 1;

FIG. 5 is a schematic representation of an inelastic scattering-based microspectrometer, for example a Raman microspectrometer, comprising the optical light-beam deflection device of FIG. 1;

FIG. 6 is a schematic cross-sectional view of the optical light-beam deflection device of FIG. 1, representing the effect of a calibration during a rotation.

### DESCRIPTION OF THE PREFERRED EMBODIMENTS

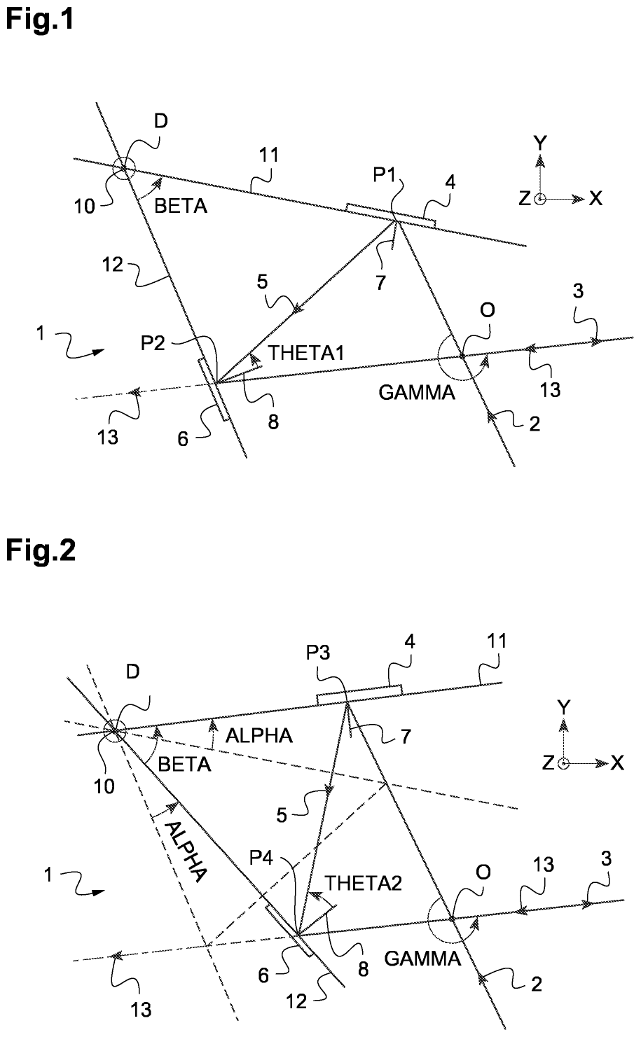

In FIG. 1 is shown an orthonormal reference system XYZ, the XY-plane being in the plane of FIG. 1 and the Z-axis being orthogonal to the plane of FIG. 1.

As shown in FIG. 1, an optical light-beam deflection device 1 comprises two flat reflective elements 4, 6. Hereinafter, the optical light-beam deflection device 1 is simply called optical deflection device 1. Here, the first reflective element 4 and/or the second reflective element 6 is a spectral filter. For example, in an embodiment that will be described hereinafter, only the second reflective element 6 is a spectral filter, and the first reflective element 4 is a mirror. In an alternative not shown, the second reflective element may be a mirror and the first reflective element is a spectral filter. According to another alternative, the first reflective element 4 and the second reflective element 6 are mirrors. According to still another alternative, the first reflective element 4 is a mirror and the second reflective element 6 is a sample having a flat reflective surface, for surface plasmon resonance measurement. According to still another alternative, the second reflective element 6 is a mirror and the first reflective element 4 is a sample having a flat reflective surface, for a surface plasmon resonance measurement.

The two flat reflective elements 4, 6 extend along a common direction. Here, the common direction is the direction perpendicular to the plane of FIG. 1, parallel to the Z-axis. In other words, the two reflective elements 4, 6 are both orthogonal to a plane of incidence. The plane of incidence is defined by an incident light beam, here called incoming light beam 2, and by the normal 7 to the first reflective element 4 at a point of incidence P1 of the incoming light beam 2 on the first reflective element 4. The plane of incidence is here coincident with the plane of FIG. 1.

As shown in FIG. 1, the first reflective element 4 reflects the incoming light beam 2 into a reflected light beam 5. By definition, the reflected light beam 5 is also in the plane of incidence. The reflected light beam 5 is reflected by the second reflective element 6 to form the outgoing light beam 3.

Here, the second reflective element 6 is arranged in such a way that its normal 8 at a point of incidence P2 of the reflected light beam 5 on the second reflective element 6 is also in the plane of incidence. Therefore, the outgoing beam 3 is also in the plane of incidence. The three light beams 2, 3, 5 form the optical path in the plane of incidence.

As shown in FIG. 1, the first reflective element 4 extends in a first plane 11. The second reflective element 6 extends in a second plane 12. The first plane 11 and the second plane 12 are secant along a line of intersection D (they are thus not parallel). As shown in FIG. 1, the first plane 11 and the second plane 12 form between each other a predetermined dihedral angle denoted BETA. The line of intersection D is parallel to the common direction.

Here, as the two flat reflective elements 4, 6 extend along the direction perpendicular to the plane of FIG. 1, the line of intersection D is also perpendicular to the plane of FIG. 1. In other words, the line D is parallel to the Z-axis.

The first reflective element 4 and the second reflective element 6 are jointly rotatable about an axis of rotation 10. This means that, if one of the two reflective elements 4, 6 performs a rotation about the axis of rotation 10, the other reflective element 6, 4 performs the same rotation about the axis of rotation 10. In other words, the first plane 11 and the second plane 12 form between each other the predetermined dihedral angle BETA whatever the rotation of the reflective elements 4, 6 about the axis of rotation 10.

As shown in FIG. 1, the axis of rotation 10 is coincident with the line of intersection D. In the present document, it is meant by axis coincident with a line, an axis and a line forming an angle lower than 10 mrad and being distant by less than 0.02 mm in the plane of incidence.

Fastening means allow the two reflective elements 4, 6 to be linked so as to be jointly rotatable about an axis of rotation 10. A rigid part may be provided, for example made of metal, on which each reflective element 4, 6 is arranged.

By way of example, the first reflective element 4 and the second reflective element 6 are fastened to a common platform 14 that is rotatable about the axis of rotation 10. Here, the platform 14 extends mainly in a plane parallel to the plane of incidence. This means that its dimension along the axis of rotation 10 is substantially lower than its dimensions in the perpendicular plane. For example, the platform 14 has generally the shape of a disk, or a portion of a disk, whose centre coincides with the axis of rotation 10.

As an alternative, this rigid part could for example be a plate forming a V whose angle is equal to the predetermined dihedral angle, each reflective element being arranged on one of the two arms of the part.

The fact that the first reflective element 4 and the second reflective element 6 are jointly rotatable about an axis of rotation 10 does not necessarily implies that the reflective elements 4, 6 are fixed relative to each other. It may for example be provided that each of the reflective elements 4, 6 is movable et/or adjustable by means of a line-point-plane system, in particular to adjust the normals 7, 8 in the plane of incidence and/or to adjust the dihedral angle BETA to a predetermined value.

The incoming light beam 2 is in a plan orthogonal to the line of intersection D. It is hence also in a plane orthogonal to the axis of rotation 10. The incoming light beam 2, the reflected light beam 5 and the outgoing light beam 3 are hence in the plane of incidence that is orthogonal to the line of intersection D. Here, the plane of incidence is the plane of FIG. 1.

The incoming light beam 2 intersects the outgoing light beam 3 at a point of intersection 0.

The incoming light beam 2 and the outgoing light beam 3 form an angle of deflection GAMMA. The optical deflection device 1 thus deflects the incoming light beam 2 by an angle of deflection GAMMA.

The terms “incoming” and “outgoing” do not in any way limit the optical deflection device 1 to a mode or direction of use. According to the principle of inverse return of light, the optical deflection device 1 also operates with a light beam propagating in the reverse direction to that shown in the figures. In particular, the optical deflection device 1 is adapted to receive a backscattered light beam 13 along the same direction and in counter-propagation with respect to the outgoing beam 3.

The angle of deflection GAMMA depends on the predetermined dihedral angle BETA. More precisely, the angle of deflection GAMMA depends only on the predetermined dihedral angle BETA, according to the formula: GAMMA=2·π−2·BETA (in radians).

The predetermined dihedral angle BETA is predetermined as a function of the chosen deflection, i.e. the angle of deflection GAMMA to be reached. In practice, the predetermined dihedral angle BETA is thus chosen as a function of the optical mount in which the optical deflection device 1 is used.

For example, if an angle of deflection GAMMA of +270 degrees is desired, the reflective elements 4, 6 are arranged in such a way as to form a dihedral angle BETA of +45 degrees. Preferably, the reflective elements 4, 6 form a dihedral angle BETA between +22.5 degrees and +67.5 degrees in such a way as to obtain an angle of deflection between +225 degrees and +315 degrees.

It may also be shown that a rotation of the optical deflection device 1 about the axis of rotation 10, i.e. the common rotation of the two reflective elements 4, 6 about the axis of rotation 10, does not change the orientation and position of the outgoing light beam 3.

Indeed, the joint movement of the two reflective elements 4, 6 during the rotation induces opposite variations of angle of incidence on the two reflective elements 4, 6. These variations compensate each other, which keeps the orientation and position of the outgoing light beam 3.

In other words, the point of intersection O and the angle of deflection GAMMA are invariant by rotation of the optical deflection device 1 about the axis of rotation 10. Contrary to the systems of the prior art, there is no lateral offset (i.e. in the plane of incidence) of the outgoing beam 3.

Obviously, this result is valid as long as the optical path is not obstructed by a part of the optical deflection device 1 (for example, by the reflective elements 4, 6 or by their fastening means).

FIGS. 1 and 2 illustrate this result of invariance of the orientation and position of the outgoing light beam 3 by rotation.

FIG. 2 shows the optical deflection device 1 of FIG. 1 having undergone a rotation by an angle ALPHA in the trigonometric direction about the axis of rotation 10. The orientation of the incoming light beam 2 with respect to the axis of rotation 10 is identical in FIGS. 1 and 2. In FIG. 2, the incoming light beam 2 is incident on the first reflective element 4 at the point of incidence P3. The reflected light beam 5 is incident on the second reflective element 6 at the point of incidence P4. The point P3 is offset with respect to the point P1 in the plane of incidence on the first reflective element 4. Likewise, the point P4 is offset with respect to the point P2 in the plane of incidence on the second reflective element 6. However, as shown in FIGS. 1 and 2, the orientation and position of the outgoing light beam 3 are kept during the rotation by an angle ALPHA.

Here, to visualize the effect of the rotation and to make easier the understanding of the mechanism, the optical deflection device 1 is subjected in the figures to a rotation by an angle ALPHA of about twenty degrees. In practice, the rotation by an angle ALPHA is lower than 5 degrees and preferably lower than 2 degrees.

In FIG. 2, the first plane 11 and the second plane 12 form between each other a predetermined dihedral angle BETA. To facilitate the reading, the positions of the first plane 11, the second plane 12 and the reflected light beam 5 before the rotation are shown in dotted lines.

The rotation of the reflective elements 4, 6 made between FIGS. 1 and 2 has for consequence:
to change the point of incidence (from P1 to P3) and the angle of incidence of the incoming light beam 2 on the first reflective element 4;
to change the point of incidence (from P2 to P4) and the angle of incidence of the reflected light beam 5 on the second reflective element 6.

The rotation of the reflective elements 4, 6 made between FIGS. 1 and 2 has also for consequence:
to increase the distance of travel of the incoming light beam 2 because it travels the distance from P1 to P3;
to change the orientation of the reflected light beam 5;
to reduce the distance of travel of the outgoing light beam 3 because it does not travel the distance from P2 to P4, while keeping its orientation and position.

For an incoming beam 2 having determined position and orientation, the optical deflection device 1 can thus be used to change the angle of incidence of a light beam on a reflective element 4, 6, while keeping the orientation and position of the outgoing beam 3.

To change the angle of incidence on one of the reflective elements 4, 6, a rotation about the axis of rotation 10 is applied to the optical deflection device 1.

Here, the angle of incidence THETA2 of the reflected light beam 5 on the second reflective element 6 after a rotation by an angle ALPHA in the trigonometric direction about the axis of rotation 10 (FIG. 2) is linked to the angle of incidence THETA1 of the reflected light beam 5 on the second reflective element 6 before the rotation (FIG. 1) by the formula: THETA2=THETA1+ALPHA. The angle THETA2 thus varies linearly as a function of the angle ALPHA and with the same sign as the angle ALPHA. To change the angle of incidence of the reflected light beam 5 on the second reflective element 6 by 1 degree, it is sufficient to apply a rotation by 1 degree to the optical deflection device 1 in the desired direction. It is therefore possible to easily adjust the angle of incidence of the reflected light beam 4 on the second reflective element 6, for example in a range of ±5 degrees about a mean angle of incidence, while keeping the angle of incidence THETA2 positive and lower than 90 degrees. An electronically and/or digitally controlled actuator may be used to control the rotation of the optical deflection device 1 with a resolution allowing an angular accuracy of the order of 0.1 degrees or 0.01 degrees.

Moreover, the rotation also changes the angle of incidence of the incoming light beam 2 on the first reflective element 4. The angle of deflection GAMMA does not vary. However, the angle of incidence of the incoming light beam 2 on the first reflective element 4 varies in the opposite direction of the angle of rotation ALPHA.

Such a device finds in particular an application in surface plasmon resonance measurement, in which it is desirable to vary the angle of incidence on a reflective surface of a sample, while keeping the position and direction of the beam after reflection. For that purpose, a light-beam deflection device as described hereinabove is used, in which the first reflective element 4 is a mirror and the second reflective element 6 is a sample having a flat reflective surface (or conversely).

Generally, the optical deflection device 1 may be used in all the optical instruments in which it is necessary to vary the angle of incidence of a light beam 2, 5 on a spectral filter operating in reflection while keeping the orientation and position of an outgoing light beam 3.

The optical deflection device 1 is particularly adapted to the inelastic scattering-based spectrometry instruments, without being limited to these latter, in particular for Raman spectrometry, but also for fluorescence spectrometry or Brillouin scattering spectrometry.

For example, it may be provided that the first reflective element 4 is a flat mirror. It may also be provided that the second reflective element 6 is a flat reflection and transmission spectral filter. The second reflective element 6 may for example be an interference filter of the stop-band, band-pass, high-pass or low-pass type.

The second reflective element 6 can thus correspond to the notch or edge filters presented in introduction, which are used in Raman spectrometry.

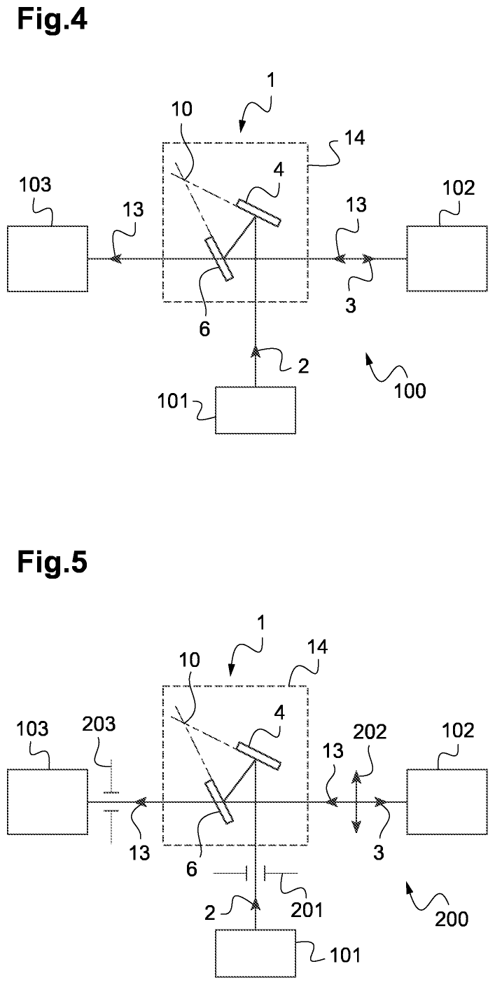

As shown in FIG. 4, the optical device may be used within the framework of Raman spectrometry. FIG. 4 schematically shows the path of a light beam in a Raman spectrometer 100 comprising the optical deflection device 1.

Here, a laser source 101 produces the incoming light beam 2. The optical deflection device 1 reflects and filters, towards the sample 102, the incoming light beam 2 to form a highly monochromatic, filtered outgoing light beam 3. For that purpose, the first reflective element 4 is a flat mirror and/or the second reflective element 6 is an interference filter. On the optical path of the incident laser beam, the interference filter is used in reflection.

The sample 102 generates the backscattered beam 13 propagating along the same direction as the outgoing beam 3 and in counter-propagation with respect to the latter. The interference filter, used in transmission, transmits the Raman scattering, for example towards the spectrum analyser 103 and reflects the reflection and the Rayleigh scattering that are at the same wavelength as the laser beam. The optical deflection device 1 is simply interposed on the optical path between the laser source 101 and the sample 102, and on the other hand, between the sample 102 and the spectrum analyser 103. The optical deflection device 1 has a reduced bulk compared to a kinematic mount of the prior art combining a rotation and a translation.

As shown in FIG. 5, the optical device may also be used within the framework of Raman microspectrometry and in particular confocal Raman microspectrometry. FIG. 5 schematically shows the path of a light beam in a Raman microspectrometer 200 comprising the optical deflection device 1.

Here, a laser source 101 produces the incoming light beam 2. The incoming light beam 2 passes through a first diaphragm 201. The optical deflection device 1 deflects, towards the sample 101, the incoming light beam 2 into a highly monochromatic, filtered outgoing light beam 3. For that purpose, the first reflective element 4 is a flat mirror and/or the second reflective element 6 is an interference filter. On the optical path of the incident laser beam, the interference filter is used in reflection.

A microscope lens 202 focuses the outgoing beam 3 in a part of the sample 102 called optical section. Advantageously, in confocal microscopy, the microscope lens 202 is arranged in such a way as to form an image of the first diaphragm 201 spatially limited in the optical section, in such a way as to obtain a measurement spatially resolved along the axis of the light beam.

The illuminated part of the sample 101 generates the backscattered beam 13 propagating along the same direction as the outgoing light beam 3 and in counter-propagation with respect to the latter. On the optical path of the backscattered beam, the interference filter is used both in transmission, to transmit the Raman scattering towards the spectrum analyser 103 by passing through a second diaphragm 203, and in reflection to separate the reflection and the Rayleigh scattering that are at the same wavelength as the laser beam. The second diaphragm 203 is arranged in such a way that the microscope lens 202 forms on the second diaphragm 203 an image of the optical section illuminated in the sample.

In this context, the optical deflection device 1 may serve to adjust the spectral response of the interference filter, for example to respond to a variation of the wavelength of the laser beam illuminating the sample 101, that while keeping the orientation and position of the outgoing beam 3 and hence of the backscattered beam 13, without changing the position of the first diaphragm 201 and of the second diaphragm 203. The optical deflection device 1 is simply inserted on the optical axis of the confocal microscope. It makes it possible to change the angle of incidence of a reflective optical element 4, 6 without changing the optical axis of the microscope.

Therefore, in the case where the first reflective element 4 is a flat mirror and the second reflective element 6 is an interference filter, the optical deflection device 1 may for example allow adjusting the cut-off wavelengths Ac of the interference filter by changing the angle of incidence of the reflected light beam 5. With THETA the angle of incidence on the second reflective element 6 and n the effective angle of refraction of the interference filter, the cut-off wavelength Ac can be given by the formula:

λc(THETA)=λc(0)\sqrt{1−sin²(THETA)/n²} [Math 1]

where λc(0) represents the design cut-off wavelength of the interference filter, i.e. the cut-off wavelength in normal incidence.

Here, the design angle of incidence of the interference filter, for example shown in FIG. 1 by the angle of incidence THETA1 of the reflected light beam 5 on the second reflective element 6 is preferably between 0 and 10 degrees. The design angle of incidence of the interference filter is the angle of incidence for which the filter has been designed.

It is possible that one of the reflective elements 4, 6 or both have reflection properties that vary over its surface. An interference filter may for example have a spectral response that varies spatially over its surface.

As the points of incidence P1, P2, P3, P4 of the light beams 2, 5 of the reflective elements 4, 6 vary spatially during the rotation, it may be useful, in particular in the case where the reflection properties of a reflective element 4, 6 vary over its surface, to move the reflective element(s) 4, 6 in order to keep the point(s) of incidence during the rotation by an angle ALPHA.

For that purpose, it may be provided, when the optical device is operated in rotation about the axis of rotation 10, that the first reflective element 4 and/or the second reflective element 6 are adapted to move in translation in the first plane 11 and/or, respectively, in the second plane 12. For example, they can be each motorized by a motor allowing a translation in their respective plane 11, 12 along the plane of incidence.

Having reflective elements 4, 6 movable in translation in their respective planes 11, 12 also makes it possible to reduce the size of the reflective elements 4, 6 and thus the cost thereof. Indeed, moving the reflective element 4, 6 ensures that the point of incidence P1, P2, P3, P4 of a light beam does not move out of the surface of the reflective element 4, 6 during a rotation by an angle ALPHA.

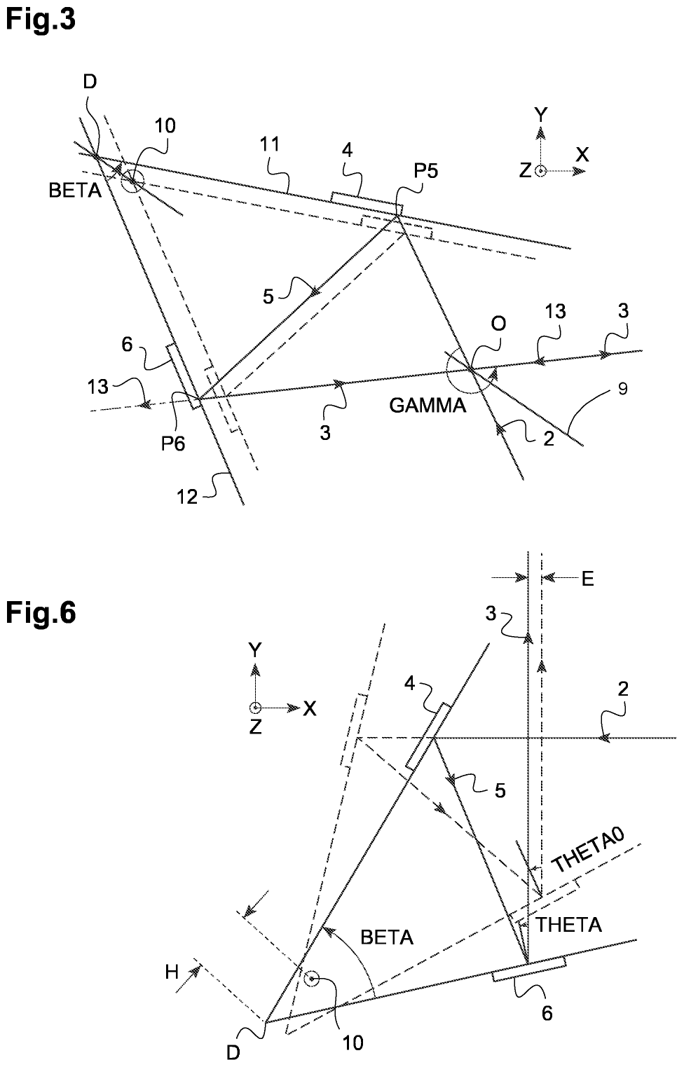

It may also be provided that the first reflective element 4 and the second reflective element 6 are adapted to move in translation in the plane of incidence, along a bisector 9 between a direction of the incoming light beam 2 and a direction of the outgoing light beam 3. In FIG. 3, this bisector 9 is the bisector of the angle formed by the incoming beam 2 and the outgoing beam 3 and that is located at the opposite of the dihedral angle BETA with respect to the point of intersection O. Here, the direction of a light beam is defined by its propagation path.

FIG. 3 shows the optical deflection device 1 of FIG. 1, in which the reflective elements 4, 6 have been translated along the bisector 9 with respect to the axis of rotation 10. To facilitate the reading, the positions of the reflective elements 4, 6, the respective plane 11, 12 thereof, and the reflected light beam 5 before the translation are shown in dotted lines.

The orientation of the incoming light beam 2 with respect to the axis of rotation 10 is identical in FIGS. 1 and 3. The incoming light beam 2 is incident on the first reflective element 4 at the point of incidence P5. The reflected light beam 5 is incident on the second reflective element 6 at the point of incidence P6. As shown in FIG. 3, the orientation and position of the outgoing light beam 3 are kept during the translation, along the bisector 9.

This translation along the bisector 9 makes it possible to adjust the position of the line of intersection D, in particular with respect to the axis of rotation 10. Indeed, when the reflective elements 4, 6 are translated, the line of intersection D is offset along the bisector 9 in the translation direction.

This adjustment may advantageously constitute a step of calibration of the optical deflection device 1 to ensure that the line of intersection D is coincident with the axis of rotation 10.

For that purpose, the two reflective elements 4, 6 may be mounted on a plate connected to the platform 14 by a guiding rail parallel to the bisector 9.

Remarkably, the fact that the axis of rotation 10 and the line of intersection D are not strictly coincident has only very little influence, during the rotation of the optical deflection device 1, on the position of the outgoing light beam 3.

The robustness of the optical deflection device 1, with respect to its calibration, makes it simple to integrate in an optical system, for example a spectrometer.

FIG. 6 illustrates, in an intentionally exaggerated manner, a lateral displacement, denoted E, of the outgoing light beam 3 during a rotation of the optical deflection device 1 in the clockwise direction. The positions of the respective elements 4, 6, the light beams 2, 5, 3 and the line of intersection D before rotation are shown in dotted lines. The error of axis H represents the distance between the axis of rotation 10 and the line of intersection D. The lateral displacement E represents the distance between the position of the outgoing light beam 3 before rotation and the position of the outgoing light beam 3 after rotation.

In the example shown in FIG. 6, the optical deflection device 1 undergoes a rotation in such a way that the angle of incidence of the reflected light beam 5 on the second reflective element 6 varies by +8 degrees. The angle of incidence varies from THETA0 to THETA according to the formula THETA=THETA0+8 degrees.

In this example, the error of axis H is set to 1 mm. The error of axis H is set to an intentionally high value to show the robustness of the optical deflection device 1.

With such an error of axis H, for a dihedral angle BETA of 45° and for a rotation of +8° degrees, the lateral displacement E of the outgoing light beam is of: 0.112 mm for an initial angle of incidence THETA0 of 3 degrees; 0 mm for an initial angle of incidence THETA0 of 8 degrees; and 0.090 for an initial angle of incidence THETA0 of 12 degrees.

By way of another example, still for an error of axis H of 1 mm, for a dihedral angle BETA of 50° this time and for a rotation of +8° degrees, the lateral displacement E of the outgoing light beam is of: 0.123 mm for an initial angle of incidence THETA0 of 3 degrees; 0 mm for an initial angle of incidence THETA0 of 8 degrees; and 0.099 for an initial angle of incidence THETA0 of 12 degrees.

In practice, for light beams of a few millimetres in diameter, these measured lateral displacements E are thus negligible, and that even in the case of a great error of axis H. Indeed, it is easy, during the calibration, to reduce the error of axis H far lower than one millimetre. Preferably, the calibration is complete when the line of intersection D is coincident with the axis of rotation 10 as mentioned hereinabove.

1. An optical light-beam deflection device comprising:
a first flat reflective element, extending in a first plane, the first reflective element being arranged in such a way as to reflect an incoming light beam into a reflected light beam, said incoming light beam and said reflected light beam defining a plane of incidence; and
a second flat reflective element extending in a second plane transverse to the plane of incidence, the second reflective element being arranged in such a way as to reflect said reflected light beam into an outgoing light beam;
said first plane and said second plane being secant along a line of intersection and forming between each other a dihedral angle, said first reflective element and said second reflective element being jointly rotatable about an axis of rotation coincident with said line of intersection, said axis of rotation being transverse to the plane of incidence.

2. The optical light-beam deflection device according to claim 1, wherein one at least among said first reflective element and said second reflective element is a spectral filter.

3. The optical light-beam deflection device according to any one of claim 1, wherein said first reflective element is a flat mirror.

4. The optical light-beam deflection device according to claim 1, wherein said second reflective element is a flat reflection filter.

5. The optical light-beam deflection device according to claim 4, wherein said filter is an interference filter of the stop-band, band-pass, high-pass or low-pass type.

6. The optical light-beam deflection device according to claim 5, wherein said interference filter operates in transmission and in reflection.

7. The optical light-beam deflection device according to claim 1, wherein said first reflective element and said second reflective element are fastened to a common platform that is rotatable about said axis of rotation.

8. The optical light-beam deflection device according to claim 1, wherein said first reflective element and/or said second reflective element is adapted to move in translation in said first plane and/or, respectively, in said second plane.

9. The optical light-beam deflection device according to claim 1, wherein said first reflective element and said second reflective element are adapted to jointly move in translation in the plane of incidence, along a bisector between a direction of the incoming light beam and a direction of the outgoing light beam.

10. The optical light-beam deflection device according to claim 1, wherein at least one of said first reflective element and second reflective element has reflection properties that vary over a surface thereof.

11. The optical light-beam deflection device according to claim 1, wherein the dihedral angle is between 20 degrees and 70 degrees.

12. An optical inelastic scattering-based spectrometer comprising an optical light-beam deflection device according to claim 1.

13. The optical spectrometer according to claim 12, combined with a confocal microscope.

14. The optical light-beam deflection device according to claim 2, wherein said first reflective element is a flat mirror.

15. The optical light-beam deflection device according to claim 3, wherein said second reflective element is a flat reflection filter.

16. The optical light-beam deflection device according to claim 2, wherein said first reflective element and said second reflective element are fastened to a common platform that is rotatable about said axis of rotation.

17. The optical light-beam deflection device according to claim 2, wherein said first reflective element and/or said second reflective element is adapted to move in translation in said first plane and/or, respectively, in said second plane.

18. The optical light-beam deflection device according to claim 2, wherein at least one of said first reflective element and second reflective element has reflection properties that vary over its surface.

19. The optical light-beam deflection device according to claim 2, wherein the dihedral angle is between 20 degrees and 70 degrees.
